(19) United States
(12) Patent Application Publication
(10) Pub. No.: US 2021/0260802 A1
(43) Pub. Date: Aug. 26, 2021

(54) INDUSTRIAL PROCESS OPTIMIZATION SYSTEM AND METHOD

(71) Applicant: Eigen Innovations Inc., Fredericton (CA)

(72) Inventors: Meaghan CHAREST-FINN, Fredericton (CA); Rickey DUBAY, Fredericton (CA); Scott EVERETT, Fredericton (CA)

(21) Appl. No.: 17/187,566

(22) Filed: Feb. 26, 2021

Related U.S. Application Data
(60) Provisional application No. 62/981,876, filed on Feb. 26, 2020.

(51) Int. Cl. B29C 45/76; G05B 19/418; B29C 45/77; B29C 45/78

(52) U.S. Cl. CPC B29C 45/766; G05B 19/41865; B29C 45/77; B29C 45/78; G05B 2219/45244; B29C 2945/76187; B29C 2945/7604; B29C 2945/76913; B29C 2945/76006; B29C 2945/76304; B29C 2945/7619; B29C 2945/7611

(57) ABSTRACT

A method or system for industrial process optimization, including sensing data about an industrial process cycle that operates according to a set of process setpoints; determining a target performance for the process cycle based on the sensed data; selecting process set-points from a hypothesis space for a future industrial process cycle based on the target performance, and updating the hypothesis space.

### RELATED APPLICATIONS

This application claims the benefit of and priority to U.S. Provisional Patent Application No. 62/981,876, filed Feb. 26, 2020, entitled “INDUSTRIAL PROCESS OPTIMIZATION SYSTEM AND METHOD”, the contents of which are incorporated herein by reference.

### FIELD

This disclosure relates generally to optimization of automated industrial processes.

### BACKGROUND

The term “Industry 4.0” (I4) describes a growing collection of technologies available for factories to improve process performance. The combination of these technologies is revolutionary in terms of moving the manufacturing industry into a next generation of functionality. The combination of data mining, machine learning methodologies, smart sensors, and a new generation of connected automation tools is quickly making cyber physical systems (CPS) the modern factory standard. To maximize the effectiveness of these systems it is necessary that all of the components of a smart process integrate fluidly.

It is projected that implementations of the technologies offered by I4 will improve process efficiency in terms of reduced waste, energy management and predictive maintenance, among other things. The development of new tools for I4 is far from peaking, new implementation methodologies such as fog computing and CPS architectures are examples of this. While the benefits of upgrading manufacturing sectors is undeniable, there are a number of challenges that need to be overcome for the practical integration of highly automated factories to be achieved. An important challenge for I4 is to develop methodologies and standards for the practical inclusion of CPS methodologies with respect to machine learning and other existing I4 technologies. It is important for industry to adopt these new technologies to remain competitive in a global market. Developing practical CPS schemes for industry to close that gap between the world of computer science and physical plant operations is key in achieving this. Effectively determining generic CPS methodologies for industry is challenging because of problem dependent machine data and plant operating characteristics. Cleaner production in the manufacturing sector is quickly becoming a standard around the world, it is imperative to develop the methodologies to achieve this.

I4 technologies can be applied to many industrial processes with a goal of improving overall performance with respect to target production goals. Examples of overall process improvement are based on quality of production, production time and energy consumption.

Thus, there is a need for methods and systems that enable effects of controllable and uncontrollable process parameters on part quality and machine performance to be determined and used to adapt process control for real-time process performance optimization.

### SUMMARY

According to an example aspect, this disclosure describes a method and system for industrial process optimization, including sensing data about an industrial process cycle that operates according to a set of process setpoints; determining target attributes for the process cycle based on the sensed data; selecting process setpoints from a hypothesis space or database for a net industrial process cycle based on the process attributes and target variables, and updating the hypothesis space.

According to a first example aspect, a computer implemented method for controlling a cyclic industrial process is disclosed. The method includes: receiving process attributes for a current sequence of process cycles; comparing the process attributes for the current sequence of process cycles with process attributes for each of a plurality of historic instances, each historic instance including process attributes for a respective historic sequence of process cycles; selecting an optimal set of one or more process setpoints based on the comparing; and applying the optimal set of one or more process setpoints to a next process cycle in the current sequence of process cycles.

In some examples, the comparing comprises determining, for each of the plurality of historic instances, a respective likeness score for the historic instance relative to the current sequence of process cycles based on a computed difference of the process attributes for the historic instance to the process attributes for the current sequence of process cycles.

In one or more of the preceding aspects each historic instance has an associated set of performance measurements, wherein selecting the optimal set of one or more process setpoints is based on: (i) selecting a historic instance having an optimal combination of likeness score and performance measurements as determined according to a defined optimization function; (ii) selecting the optimal set of one or more process setpoints from setpoints included in the process attributes for the selected historic instance.

In one or more of the preceding aspects the process attributes for each historic instance include a respective attribute set for each of a defined number of process cycles including a final process cycle of the historic instance, the final process cycle being known as corresponding to a successful process cycle outcome; the set of performance measurements associated with each historic instance are based on the respective attribute set for the final process cycle of the historic instance; and the optimal set of one or more process setpoints are selected from setpoints included in the attribute set of the final process cycle of the selected historic instance.

In one or more of the preceding aspects, the cyclic industrial process is an injection molding process and each process cycle generates a respective injection molded part, wherein: the process attributes for the current sequence of process cycles and for each of a plurality of historic instances include: (i) one or more measured attributes selected from a group including one or more of: coolant temperature, injection speed, screw position, hydraulic back pressure, barrel temperature, barrel pressure, energy consumption and part quality and (ii) one or more setpoint attributes selected from a group including one or more of: injection setpoint, packing setpoint, holding setpoint, plasticate setpoint, cool time setpoint, pack time setpoint, hold time setpoint and coolant flow rate setpoint; and the performance measurements associated with each of the plurality of historic instances includes one more of: a quality index; an energy index and a cycle time.

In one or more of the preceding aspects, the method includes receiving process attributes for a plurality of process cycles performed by the industrial process over a period of time; organizing the process attributes into multiple unique instances, each unique instance including the process attributes for a defined number of the process cycles, each of the unique instances having been identified according to predefined criteria as corresponding to a successful process outcome; selecting at least some of the unique instances to use for the plurality of historic instances.

In some examples, the method includes updating the plurality of historic instances over time by adding new instances from the multiple unique instances to replace instances included in the plurality of historic instances.

In one or more of the preceding aspects, the method includes adding perturbances to a subset of the process attributes included in at least some of the multiple unique instances to introduce variations in future process cycles.

In one or more of the preceding aspects organizing the process attributes into the multiple unique instances comprises: organizing the process attributes into candidate instances, each candidate instance including the process attributes for the defined number of the process cycles; computing one or more performance measurements for each of the candidate instances; determining, based on the computed performance measurements, which of the candidate instances corresponds to a successful process outcome; and selecting the candidate instances that have been determined to correspond to a successful process outcome for inclusion in the multiple unique instances.

In one or more of the preceding aspects, one or more performance measurements for each of the candidate instances includes a quality metric that is based on the quality of at least a final process cycle of the candidate instance.

According to a further example aspect a computer implemented method for controlling a cyclic industrial process is disclosed that comprises: assembling a main dataset that includes multiple historic instances for the industrial process, each of the historic instances including process attributes for a respective historic sequence of process cycles; selecting, based on one or more intended process attributes for future process cycles, a process dataset that includes a subset of the historic instances; selecting and applying an optimal set of one or more process setpoints for the industrial process during real-time operation of the industrial process based on a comparison of process attributes received in respect of process cycles completed during the real-time operation and the process attributes of the historic instances included in the process dataset.

According to a further example aspect is a process control system for controlling a cyclic industrial process, comprising: a first processing unit comprising one or more processing devices and one or more electronic storages that store non-transient software instructions that, when executed by the one or more processing devices, configure the first processing unit to: receive process attributes for a current sequence of process cycles; compare the process attributes for the current sequence of process cycles with process attributes for each of a plurality of historic instances, each historic instance including process attributes for a respective historic sequence of process cycles; select an optimal set of one or more process setpoints based on the comparing; and apply the optimal set of one or more process setpoints to a next process cycle in the current sequence of process cycles.

In some example aspects, the system also includes a second processing unit comprising one or more further processing devices and one or more further electronic storages that store further non-transient software instructions that, when executed by the one or more further processing devices, configure the second processing unit to: receive process attributes for a plurality of process cycles performed by the industrial process over a period of time; organize the process attributes into multiple unique instances, each unique instance including the process attributes for a defined number of the process cycles, each of the unique instances having been identified according to predefined criteria as corresponding to a successful process outcome; select at least some of the unique instances to use for the plurality of historic instances; and provide the plurality of historic instances to the first processing unit.

### BRIEF DESCRIPTION OF THE DRAWINGS

Reference will now be made, by way of example, to the accompanying drawings which show example embodiments of the present application, and in which:

FIG. 1 is a schematic block diagram of an injection molding system.

FIG. 2 are schematic drawings of injection molded parts.

FIG. 3 is a block diagram of a general industrial process optimization system according to example embodiments.

FIG. 4 is a representation of a hypothesis space H that is used by the general industrial process optimization system of FIG. 3.

FIG. 5 is a plot showing performance scores corresponding to a hypothesis space.

FIG. 6 is a flow diagram of a process performed by a process control module of the general industrial process optimization system of FIG. 3.

FIG. 7 is a block diagram of a further example of a general industrial process optimization system applied to multiple industrial processes according to example embodiments.

FIG. 8 is a block diagram of a processing unit that may be used to implement modules of the system according to example embodiments.

Similar reference numerals may have been used in different figures to denote similar components.

### DESCRIPTION OF EXAMPLE EMBODIMENTS

The present disclosure describes methods and systems for process optimization that can be applied in the context of I4 technologies. Although the methods and systems described herein can be applied to many different industrial and manufacturing processes, one area of interest is the injection molding process. Accordingly, illustrative embodiments will be described in the context of an injection molding process, although the systems and methods disclosed herein are not limited to injection molding process applications.

Injection molding (IM) is a process by which polymer pellets are fed into a heated barrel through a hopper. The polymer pellets are heated and pulled through the barrel by a rotating screw. This process creates a melt that is injected into a mold cavity of a mold then cooled. The IM process presents itself as an important complex automation problem for the design of a cyber physical system (CPS) because the IM process is comprised of multiple highly dependent operations. The IM process considers material, temperatures, flow rates, speeds and pressures to produce a quality product. These process parameters are the base of many manufacturing operations, and thus a generalized manufacturing CPS can be designed for scalability using the IM process as a template process.

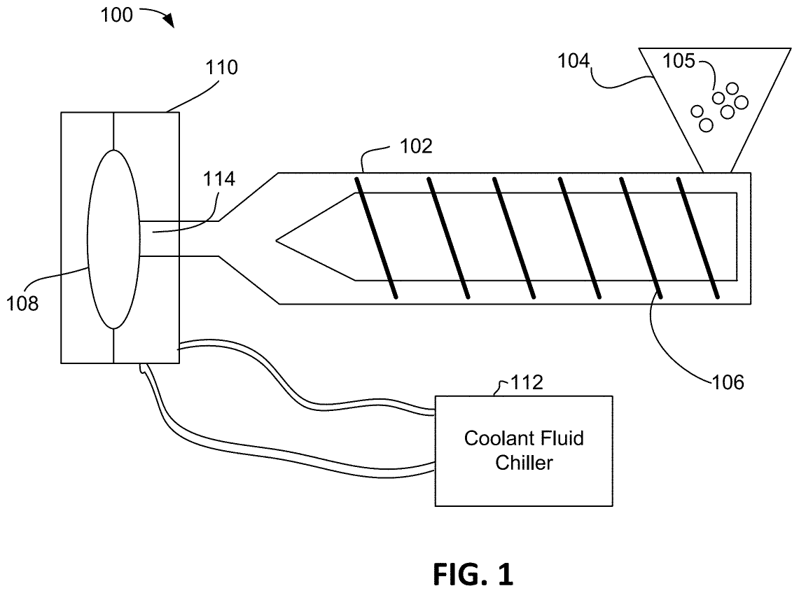

The IM process can be considered as a combination of sub-processes that can be divided into three categories or phases, namely: (1) plastication, (2) injection, and (3) cooling. An example of an IM machine 100 is shown in FIG. 1. The IM machine 100 includes a hopper 104 that feeds polymer pellets 105 to a feed end of a heated barrel 102. During plastication, a rotating screw 106 inside the heated barrel 102 draws polymer pellets 105 into the barrel 102 where they begin to melt. The rotating action of the screw 106 moves the polymer to the front of the barrel 102. During injection, the polymer melt that is at the front of the screw 102 will be pushed through a mold gate 114 into a mold cavity 108 of a mold 110. During cooling, a coolant fluid chiller 112 pumps coolant through the mold 110 to cool the polymer within the mold cavity 108.

The final quality of the molded part will be dependent on a number of pre-molding factors that exist before the plastication phase, including: (1) polymer material composition (e.g., percentage of recycled material); (2) presence and amount of polymer additives such as color and softeners; and (3) material state and storage temperatures. If the impact of these factors can be identified during plastication phase of part production, the resulting production problems can be mitigated by adjusting the parameters for subsequent sub-processes.

The injection phase includes filling the mold cavity 108 with polymer, packing polymer melt into the mold cavity 108, and holding the polymer in the mold cavity 108 until the gate 114 has frozen. The gate 114 is the orifice through which the polymer enters the mold cavity 108. The polymer located within the gate 114 will generally form the smallest cross section of the ejected part and is expected to harden first. The injection phase of part production is directly tied to the pressure inside the mold cavity 108. Typically, a consistent cavity pressure profile within target parameters will result in consistent quality part production. There are many challenges to controlling cavity pressure: (1) the filling and packing operations can cause a quick rise to peak pressure; (2) the controllability of the pressure profile is sensitive to the states of the mold and the material; and (3) it is often expensive and impractical to have pressure sensors in an injection mold cavity 108. In example embodiments, the conditions that exist in the mold cavity 108 are inferred based on observable outcomes over a number of cycles in addition to key sensor values such as back pressure and barrel pressure.

Once the gate 114 has frozen, the cooling phase has begun. This is the last opportunity during the molding cycle to effect the production outcome. As the polymer solidifies in the mold cavity 108 it is important that internal stresses are allowed to dissipate to avoid undesirable mechanical properties of the part such as warping. The main control variables in the cooling phase are coolant flow rates and temperatures, which are controlled by a coolant fluid chiller 112.

In the past, various methods have been used to improve consistency and distribution of cooling such as predictive models, conformal cooling and pulse cooling. The main challenges to consider with respect to the cooling phase of a cycle are cooling limitations due to part geometry and inconsistency of overall mold temperature. Cooling is the longest part of the IM cycle and is often the subject of cycle time reduction tactics.

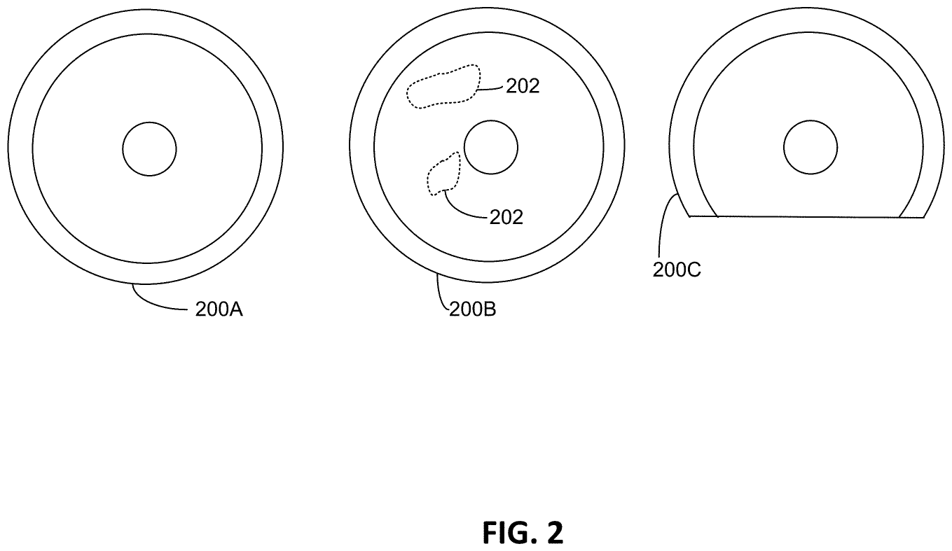

For illustrative purposes, FIG. 2 illustrates an example of sample parts (for example a duct cover) formed during different cycles through an injection molding process. The part labelled 200A represents a “good” part. The part labelled 200B represents a poor quality part that has been affected by air bubbles 202, which may for example correspond to a “flash” molding process. The part labelled 200C represents a further poor quality part lacking sufficient polymer material and corresponds to a “short shot”.

Example embodiments of a general industrial process optimization (GIPO) system that can be applied to a variety of industrial and manufacturing processes (including an IM process) will now be described. The GIPO system disclosed herein considers a manufacturing process where a task or number of tasks are repeated a large number of times with each repetition treated as a cycle. An example embodiment is presented below in the context of plastic injection molding, but the GIPO system disclosed herein can also be applied to a wider range of industrial applications, including industrial processes in which the repeated cycles may not be sequential.

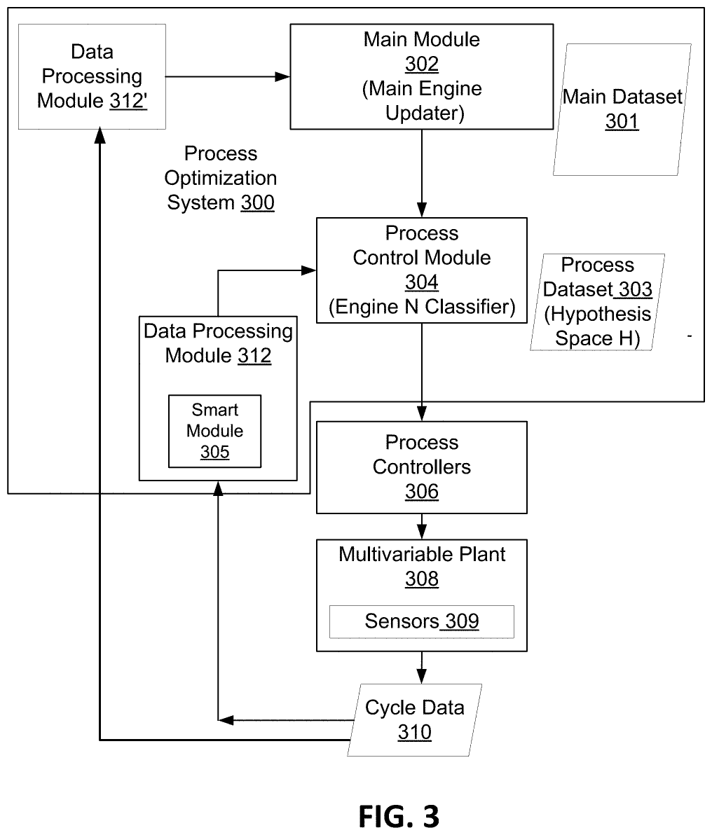

FIG. 3 illustrates components of a GIPO system 300 applied to an industrial process according to example embodiments. As will be described in greater detail below, GIPO system 300 includes a main module 302 (e.g., main engine updater), at least one process control module 304 (e.g., engine N classifier), and a data processing module 312 (e.g., data filter). GIPO system 300 interacts with an industrial process that includes controllers 306, a multivariable plant 308, and sensors 309 for collecting cycle data 310.

Plant and System Controllers

A multivariable plant 308 is made up of one or more physical production components such as machinery or processes that produce measurable variables in the form of cycle data 310. Measurable variables include any measurement, for example measurements taken by sensors 309, that can be digitally processed. Multivariable plant 308 can include one or more machines or processes that are subject to automated control by one or more controllers 306 (which may for example be existing or legacy controllers). In example embodiments, the GIPO system 300 achieves desired improvement goals by determining optimal setpoints or combinations of setpoints to send to the plant controllers 306 based on measured values (cycle data 310) that directly or indirectly affect the production process outcome.

Data Processing Module/Data Filter

The cycle data 310 produced in an industrial setting can be large in volume. In at least some examples, preprocessing can be applied by a data processing module 312 that includes one or more data filters to reduce the dimensionality of the sensed cycle data 310 and to filter out noise. Data processing module 312 can be configured to limit cycle data 310 to the amount and type of data that is useful in selecting a set of setpoints that will factor in a final operating point decision for the GIPO system 300. For example, as discussed in greater detail below, in the case of IM, the data processing module 312 may include a smart module 305 that employs a machine learned predictive function to translate thermal images and other attribute data into quality values by considering key features extracted from sensor measurements. By way of example, the systems and methods described in U.S. Pat. No. 10,268,927 issued Apr. 23, 2019, to Eigen Innovations Inc. may be used to implement a smart module 305 that can apply to a quality label or classification to a part (e.g., “Good” or “Bad”) according to example embodiments. The contents of U.S. Pat. No. 10,268,927 are incorporated herein by reference.

In some examples, the filtering applied by data processing module 312, including a classification function performed by smart module 305 could be specified by the main module 302.

Process Control Module (Engine N Classifier)—Setpoint Selector

Process control module 304 is configured to select an optimal set of setpoints from a hypothesis space H to achieve a target optimization goal for the next process cycle (e.g., cycle i+1). In an example embodiment, the hypothesis space H is represented in a digitally stored process dataset 303. The hypothesis space H stores historical data about the operating conditions that correspond to a plurality of industrial process sequences. In example embodiments, process control module 304 is configured to provide setpoints for controllers 306 for multivariable plant 308, and in this regard functions as an engine classifier for the particular multivariable plant 308. In example embodiments, multiple plants may be each associated with a respective process control module 304. Thus, there may be multiple process control modules 304/engine classifiers, with each module/classifier corresponding to a specific controller or set of controllers 306, such that “N” refers to a generic process control module 304/engine classier. In example embodiments, the target optimization goal for process control module 304 can be quality, energy management, tool-wear mitigation, cycle time, or a weighted combination of these target variables and/or any other process performance marker that can be measured or inferred. The following constraints for process control module 304 are considered in illustrated examples for practicality: (1) the change in setpoint from one cycle to another should be limited, and (2) processing time for solving the objective must be done between cycles and should be kept to a minimum. An example format for a setpoint selection function performed by process control module 304 is as follows:

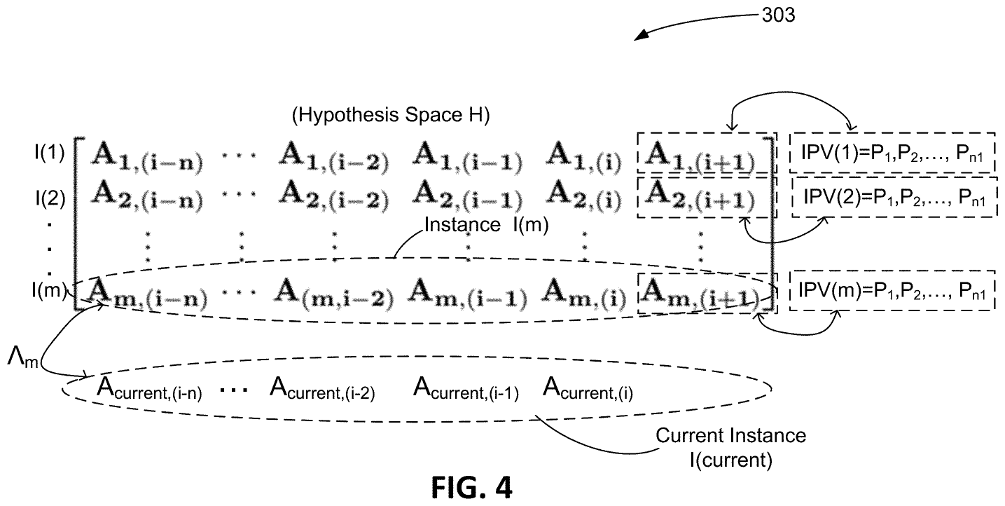

S=Hₘₐₓ{α_{Λ}Λ+α₁P₁+α₂P₂+ . . . +αₙ₁Pₙ₁} (1)

Where: S is a list of optimal process setpoints; H is a hypothesis space; Λ is a likeness score; Pᵢ (i∈1, . . . , n1) are performance measurements (such as a product quality value) and αᵢ (i∈Λ, 1, . . . , n1) are corresponding weighting factors. In an example embodiment, the hypothesis space H represented in process dataset 303 follows the format shown in FIG. 4.

As shown in FIG. 4, in an example embodiment hypothesis space H is a 2-dimensional array of array elements that each specify a set of attributes A_{r,c} (where r∈1, . . . , m and c∈i−n, . . . i+1)) that describe a set of operating conditions of a historic process cycle of the multivariable plant 308. Each attribute set A_{r,c} includes a list of attributes (which may for example be arranged as a multi-dimensional vector) that can include both process parameter setpoints used for the process cycle and the measured values resulting from the parameter setpoints. Every row in hypothesis space H presents a discrete sequence of n+2 process cycles with a successful final process cycle i+1 performed by multivariable plant 308. Accordingly, each row represents a respective historical instance I(1), . . . , I(m) (where instance refers to a sequence of process cycles) that had a successful outcome. Hypothesis space H includes m historical instances, with each instance including a row of n+2 attribute sets A_{r,(i-n)}, . . . Aᵣ₍ᵢ₊₁₎, each of which describes a respective successive process cycle. The attribute set Aᵣ₍ᵢ₊₁₎ will correspond to a process cycle that had a successful outcome (according to pre-defined criteria). The set of attributes contained within the attribute set A_{(r,c)} for a cycle c within a production sequence (i.e. instance I(r)) may include, among other things: setpoint attributes that each define a respective setpoint input to the controllers 306; input material attributes that define properties of the physical materials provided to the multivariable plant 308; and measured attributes that represented data generated by data processing module 312 based on sensed cycle data 310.

As indicated above, n1 performance measurements P₁ to Pₙ₁ are included in the setpoint selection function (1). In example embodiments, a respective instance performance vector (IPV(1), . . . , IPV(m)) is determined for each instance I(1), . . . , I(m). Each instance performance vector IPV( ) is an n1-dimensional vector that includes n instance-specific performance measurements P₁ to Pₙ₁. The instance performance vectors IPV(1), . . . , IPV(m) can be included in process dataset 303 with hypothesis space H. In some examples, instance-specific performance measurements P₁ to Pₙ₁ for an instance I(r) are determined based on the final process cycle attribute set A_{r,(i+1)} of the instance.

During real-time operation of multivariable plant 308, as each process cycle (e.g. current cycle i) is completed, a current attribute set A_{current,(i)} is generated for the just completed current cycle i in real-time by process control module 304. The current attribute set A_{current,(i)} describes the operating conditions for the process cycle i as the process cycle finishes. The attribute set A_{current,(i)} for the most recent cycle I, together with the attribute sets A_{current,(i-n)} to A_{current,(i-1)} determined in respect of the n previous cycles, collectively form a current instance I(current) (i.e., a current sequence of n+1 process cycles) that can be compared with each of the instances I(1) to I(m) included in the historical hypothesis space H to determine a respective likeness score Λ₁ to Λₘ between the current process cycle sequence attribute sets A_{current,(i-n)} to A_{current,(i)} of the current instance I(current) with the respective attribute sets of each of the historical instances I(1) to I(m). In example embodiments, process control module 304 implements an algorithm that is a version of a K-nearest neighbor classifier algorithm. The respective likeness scores Λ₁ to Λₘ between the current instance I(current) and each historical instance I(1) to I(m) is calculated using a percent difference between each attribute from the current attribute sets A_{current,(i-n)} to A_{current,(i)} with the corresponding attribute in the attribute sets A_{r,(i-n)} to A_{r,(i)} for the respective historical instance I(1) to I(m). A mean squared error calculation is then used to generate a single number likeness score Λ₁, . . . , Λₘ for each respective historical instance I(1) to I(m). By way of illustration, the likeness score calculation for instance I(m) can be computed as:

$${Λ}_{m} = \sqrt{{\sum }_{i - n}^{i} {( 2 [ \frac{\vert {a}_{i , j} - {a}_{m , i , j} \vert}{{a}_{i , j} + {a}_{m , i , j}} ] 100 )}^{2}}$$

Where: j in the term a_{m,i,j} represents the iterations within the attribute set A_{m,(i)} from the historical hypothesis set H; and the represents individual attributes from the attribute set A_{current,(i)}.

Accordingly, in the example of likeness score Λₘ, as indicated in FIG. 4, when comparing the current instance I(current) and the historical instance I(m), the score will be based on a sum of the comparison, attribute type by attribute type, of the attributes in attribute set A_{current,(i)} to those in historic attribute set A_{m,(i)}; the attributes in attribute set A_{current,(i-1)}, to those in historic attribute set A_{m,(i-1)}; and so on, with the attributes in attribute set A_{current,(i-n)}, being compared to those in historic attribute set A_{m,(i-n)}. In this manner, process control module 304 determines likeness scores Λ₁ to Λₘ for each of the historical instances I(1) to I(m) relative to the current instance I(current).

Based on the determined likeness scores Λ₁ to Λₘ, the process control module 304 can select which instance I(r) most closely represents the current instance I(current). In the selected instance I(r), the attribute set A_{r,(i+1)} will include the setpoint attributes used for the (i+1)^{th} process cycle, which as described above, is known to have had a successful outcome. Thus, use of the same setpoints for the upcoming current (i+1) process cycle has a high probability of resulting in a successful outcome. As will be appreciated from function (1) above, in example embodiments, selection of a historic instance I(r) from the hypothesis space H is not performed solely based on the instance having the highest likeness score. Rather, the likeness score is just one weighted factor. The performance measurements Pᵢ to Pₙ calculated in respect of each historic instance are also considered as respective weighted factors when selecting historic instance I(r). In particular, the historic instance I(r) having the highest combination of weighted likeness score and weighted performance measurements is selected as the historic instance I(r). The setpoint attributes of the corresponding historic attribute set A_{r,(i+1)} are then selected by process control module 304 and communicated to controllers 306 for the upcoming current (i+1) process cycle.

Accordingly, at the end of every cycle after the likeness scores are obtained, an optimal set of setpoint attributes are selected from hypothesis space H based on function (1). When the likeness score Λ is heavily weighted (e.g., an is large compared to performance measurement weights α₁ to α_{N1}) progression from one operating state to another will be slow. In some cases this is desirable, and if not then the weights α_{Λ} and α₁ to α_{N1} can be adjusted accordingly. In example embodiments, weights α_{Λ} and α₁ to α_{N1} are hyperparmeters. It will be noted that the most computationally intensive operations undertaken by the process control module 304 is determining the likeness scores and selecting the optimal instance based on the weighted likeness scores and performance measurements. Thus, the computational demands are regulated by the size of hypothesis space H and the number of performance measurements.

In some examples, the functionality of data processing module 312 and process control module 304 may be incorporated or integrated into a common processing system (e.g. on the same computing device.)

Main Module/Main Engine Updater

The main module 302 is responsible for populating array elements A_{r,c} (for all r∈1, . . . , m and c∈i−n, . . . , i+1) of the hypothesis space H represented in the process dataset 303 for each engine process control module 304. In at least some examples, main module 302 maintains a master or main dataset 301 that includes attributes for multiple scenarios for multiple multivariable plants 308. The main module 302 may populate the hypothesis space H of a process dataset 303 from attributes associated with relevant sequences represented in main dataset 301.

As new attribute instances I are created, main module 302 may add the attribute sets for new scenarios to the hypothesis space H process dataset 303 based on predetermined criteria. In example embodiments, the main module 302 sets a limitation to the size of the hypothesis space H accessible to process control module 304 to ensure timely processing by process control module 304. The addition, removal or replacement of attributes sets in the hypothesis space H are performed by main module 302 with consideration of the data processing capabilities and techniques applied by process control module 304. The distribution of operations between the main module 302 and the process control module 304 can allow the separation of cycle to cycle attributes (e.g., pressures and temperatures) and long term attributes variables (e.g., source material properties and manufacture part). For example, if main module 302 is aware that the multivariable plant 308 will be performing an upcoming set of processing cycles using materials that will consistently have the same material attributes, then those material attributes need not be specified in the hypothesis space H of the process dataset 303; rather, the main module 302 may configure the process control module 304 for the upcoming process cycles by including only the setpoint attributes and measured attributes in the process dataset 303 that are relevant for the upcoming cycles. Additionally, main module 302 may instruct the process control module 304 of the specific weighting parameters (α_{Λ} and α₁ to αₙ₁) and performance measurements (Pᵢ to Pₙ₁) to use for setpoint selection function (1).

This distribution of operations between the main module 302 and the process control module 304 may in some applications enable the process control module to be configured in an optimal manner to function efficiently for an upcoming set of process cycles. Such a distributed configuration allows mitigation of the curse of dimensionality by providing a real-time setpoint selection methodology at the process control module 304, while taking advantage of a slower, more complex process optimization routine at the main module 302.

In example embodiments, main module 302 is configured to create waypoints scenarios that can be incorporated into future process scenarios that are then added to the hypothesis space H of a process dataset 303. Waypoint scenarios are sequence sets of attribute instances that are fabricated based on the belief that a better operating condition scenario may exist than the examples provided in the hypothesis space H of the process dataset 303. These waypoint scenarios can be created in a number of ways, for example: by an experienced operator or by an artificial intelligent inference routine such as Bayesian networks. In example embodiments, waypoint scenarios are created by slight perturbation of the attributes of known scenarios. This enables variance in the hypothesis space H. In example embodiments the attributes associated with fabricated waypoint scenarios are configured to be weighted heavily in equation 1 to ensure that they will be tested. In the presented example this is done by assigning the waypoints scenarios high performance measurement attribute scores.

In example embodiments, main module 302 also receives cycle data 310. In some examples, main module 302 includes or has access to a further data processing module 312′ that is similar to data processing module 312. The data processing module 312′ may include a smart module 305 and other data filtering functions that process cycle data 310 in a different manner that the data processing module 312 that enables the system 300 to take advantage of a higher computational capability resources available to main module 302 relative to those of real-time process control module 304.

Example IM Application

In an example embodiment, GIPO system 300 is applied in the context of an industrial IM machine such as the IM system 100 illustrated in FIG. 1. In an illustrative example, multivariable plant 308 includes the IM system 100, controllers 306 include controllers that control the speed of screw 106, temperature of heated barrel 102, operation of coolant fluid chiller 112, and mold 110 part ejection. The IM system 100 is provided with a plurality of sensors 309 to measure cycle data 310. An example of the raw cycle data 310 attributes measured by sensors 309 is listed in Table 1 below:

TABLE 1
Attributes Measured by Sensors:

Coolant Temperature Into Mold
Coolant Temperature Out of Mold
Coolant Flow Rate
Injection Speed
Screw Position
Hydraulic Back Pressure
Barrel Temperatures
Barrel Pressures
Current Sensors (9)
Thermal Image Sensors

In an example embodiment, data processing module 312′ is configured to collect process cycle data (e.g. cycle data 310) from the IM system 100 and store it for data mining and processing by main module 302. In some examples, a Human Machine Interface (e.g., an interface created using PyQTgraph, PyDaqmx and other standard python libraries) can provide an interface with the IM system 308. The controllers 306 for IM system 100 allows external control of the plastication, injection (pack and hold) and cooling phases of the IM cycle, which can be controlled using industrial control methodologies.

In an example embodiment, standard soft filtering techniques are applied at one or more data filters implemented by data processing modules 312 and 312′ to correct noisy signals and DC offsets that are present in raw cycle data 310. Additionally, in order to prepare the cycle data 310 for process control module 304 and main module 302, further data formatting and preprocessing is also performed at data processing modules 312, 312′. In the case of IM system 100, new cycle data 310 data is processed by data filters of data processing modules 312 and 312′ and provided to process control module 304 and main module 302, respectively, at the end of every cycle. The data generated is formatted to match the attributes included in hypothesis space H.

An example of setpoint attributes and measured attributes for an IM cycle process scenario can be found in table 2:

TABLE 2
Attribute list

| Attributes | Values | Units |
|---|---|---|
| SETPOINT ATTRIBUTES | | |
| Injection Setpoint | 50-112 | mm/s |
| Packing Setpoint | 0-160 | MPa |
| Holding Setpoint | 0-160 | MPa |
| Plasticate Setpoint | 0-160 | MPa |
| Cool Time Setpoint | 5-20 | seconds |
| Pack Time Setpoint | 0-10 | seconds |
| Hold Time Setpoint | 0-10 | seconds |
| Coolant Flow Rate Setpoint | 0-30 | L/min |
| MEASURED ATTRIBUTES | | |
| Coolant Temperature (In-Out) | 10-25 | ° C. |
| Coolant Flow Rate | 0-30 | L/min |
| Injection Speed | 0-112 | mm/sec |
| Screw Position | 21.6 | cm |
| Hydraulic Back Pressure | 0-160 | MPA |
| Barrel Temperatures | 200 | ° C. |
| Barrel Pressure | 0-20 | MPA |
| Current Sensors (9) | 0-50 | Amps |
| Thermal Imaging Sensor Data | Quality | Short Shot, % |
| (for smart module) | | Good Part, % |
| | | Flash, % |

Although polymer pressure and temperature data can be excellent indicators of the IM process, these values are not easy to control directly and are often impractical to obtain. For this reason direct measures of these attributes are not included in the attribute list of Table 2.

Process Control Module Implementation

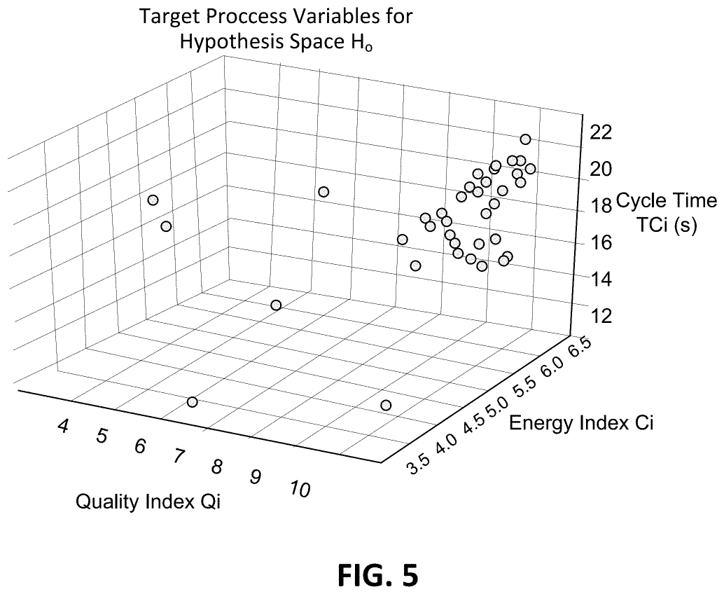

As part of a pre-production process, in example embodiments, an initial hypothesis space H₀ for process dataset 303 is generated for the process control module 304 by main module 302 based on measured cycle data 310 for an initial test run of parts. In the IM example, each process cycle i produces a respective part i. By way of example, initial hypothesis space H₀ may be generated by producing 100 parts with random process setpoints within the setpoint attribute value ranges indicated in table 2. In example embodiments, three target process variables (e.g., performance measurements P₁, . . . , Pₙ₁, where n1=3) are determined by main module 302 for the test run parts: a quality score (quality index Qi, corresponding to performance measurement Pᵢ), an energy score (energy index Ci, corresponding to performance measurement P₂) and a cycle time score (cycle time TCi, corresponding to performance measurement P₃). An example of target process variable scores resulting from a test run of 100 parts (each part represented as a circle) for an initial set of random process setpoints is shown in FIG. 5. The test run of 100 parts results in 100 sets of setpoint attributes, measured attributes, and calculated performance measure attributes that can be arranged into sequences of n+2 process cycles (corresponding to N+2 parts), with each sequence being a candidate instance for inclusion in hypothesis space H₀. Different candidate instances can include the same process cycles/parts (e.g., test parts x−1 and x may correspond to process cycles i and i+1 in one candidate instance, and correspond to process cycles i−1 and i in a further candidate instance) but each candidate instance will include a unique sequence of consecutively produced parts.

In an example embodiment, the cycle time index, TCi, is equal to the sum of cooling time, packing time and holding time. The energy index, Ci, is equal to the sum of the current drawn at each sampling instant over a cycle and then normalized. The quality index, Qi, is determined as follows. For each part resulting from a process cycle, the smart module 305 is configured to generate a quality label corresponding to: “good part” (label value 1), “short shot” (label value 2) or “flash” (label value 3), along with a respective probability value p that indicates a certainty that the label is correct. A quality score for the part is determined by selecting the generated label value (e.g., 1, 2 or 3) having the highest probability value p and adding the selected label value ½ of its associated probability value p (e.g., p/2). In an example embodiment, the quality index score Qi for a part (e.g., Part i) is the sum of the current part quality score and a defined number n (e.g., two) of previous part quality scores. The test run parts are then each classified as “good/pass” or “bad/fail” based on quality index Qi.

Each of the candidate instances are then classified as “successful” or “not successful” based on whether the final test run parts (e.g., part i+1) represented in the candidate instance is a “good” part or a “bad” part based on its quality index Qi. The candidate instances that are not successful (i.e., the final part quality index Qi does not meet a defined quality score threshold) are rejected. The candidate instances that are successful (i.e., the final part in the instance has a quality index Qi that achieves the defined quality score threshold) are added as respective instances I(r) (e.g., as rows) to the initial hypothesis space H₀. Additionally, the quality index Qi, cycle time index TCi and index Ci for the final process cycle/part i+1 of the instance I(r) are set as the instance performance vector IPV(r) that corresponds to the instance I(r).

Once the initial hypothesis space H₀ and the corresponding instance performance vectors IPV have been defined by the main module 302 they are provided to process control module 304 as process dataset 303.

The process control module 304 is configured to function in real-time and process the most recent data that is generated upon mold opening and part ejection. The cycle data 310 collected and formatted by the data filters of data processing module 312 is compared to respective attributes in the hypothesis space H and each attribute sequence is given a score based on Function 1.

The setpoint attributes corresponding to the final process cycle (i+1) of the historical instance I(r) from hypothesis space H having the highest score are then used for the next real-time process cycle i+1.

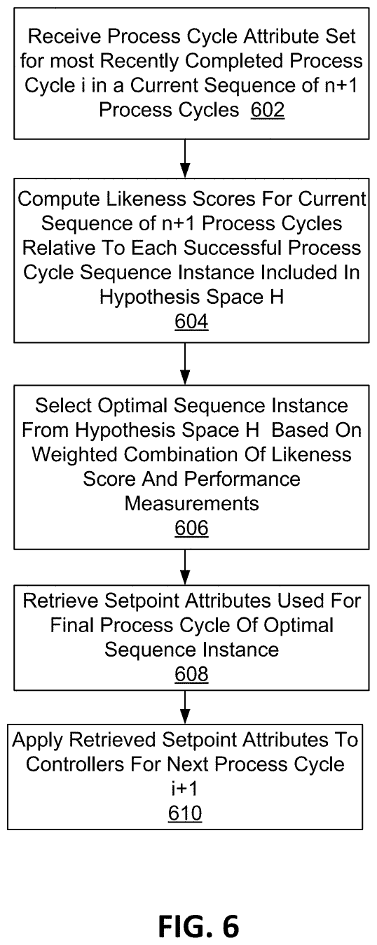

FIG. 6 is a block diagram that summarizes a method that is performed by process control module 304 during a real-time process cycle of IM system 100. As indicated at 602, process control module 304(2) receives, from data processing module 312, the process cycle attribute set A_{current,(i)} for the most recent process cycle i performed by IM system 100 in a current sequence instance I(current) of n+1 process cycles. The process control module 304(2) will have access to the process cycle attribute sets A_{current,(i-1)} to A_{current,(i-n)} from prior cycle data retrieval steps.

As indicated at 604, process control module 304 then computes likeness scores Λ₁ to Λₘ for the current sequence of n+1 process cycles (e.g., the current sequence instance I(current)) relative to each of the historic successful process cycle sequence instances I(1), . . . , I(m) included in Hypothesis Space H.

As indicated at 606, process control module 304 then selects the optimal sequence instance Iₒₚₜᵢₘₐₗ from sequence instances I(1), . . . , I(m) by determining which of the historic sequences I(1), . . . , I(m) has a maximum optimization score based on the weighted combination of the likeness score for the historic sequence instance and selected performance measurements for the historic sequence instance. In the illustrated example, the performance measurements that are used are a quality index Qi+1, power index Ci+1 and cycle time CTi+1 calculated by the mail module 302 during configuration of the hypothesis space H for the final process cycle i+1 included in the historic sequence instance.

As indicated at 608, process control module 304 then retrieves the setpoint attributes from the attribute set Aₒₚₜᵢₘₐₗ(i+1). For example, in the case of IM system 100, these setpoint attributes can include one or more of: injection setpoint, packing setpoint, holding setpoint, plasticate setpoint, cool time setpoint, pack time setpoint, and hold time setpoint.

As indicated at 610, control module 304 then communicates the retrieved setpoint attributes to the controllers 306 for application by the IM system 100 for the next process cycle i+1 in the current sequence instance I(current).

Main Module Updater

In example embodiments, the main module 302 continuously receives updated process cycle data 310 that has been filtered and preprocessed by data processing module 312′. This information can be used to update the hypothesis space H and instance performance vectors IPVs that are included in process dataset 303 over time.

The relative weightings applied to the likeness scores and performance measurements can be varied to create different hypothesis spaces that each emphasize different performance measurements. For example, a first hypothesis set H₁ and associated instance performance vectors IPVs may emphasize production cycle time and reduced energy consumption relative to quality, and a second hypothesis set H₂ and associated instance performance vectors IPVs may emphasize quality relative to production cycle time and energy consumption. In the case where a high quality part is desired, the second hypothesis set H₂ and associated instance performance vectors IPVs can be used to populate the process dataset 303. In the case where lower quality, cheaper versions of the same part are desired, the first hypothesis set H₁ and associated instance performance vectors IPVs can be used to populate the process dataset 303.

In example embodiments, to improve system performance, waypoint scenarios can be added to the hypothesis space H by main module 302. Only the setpoints that were included in the original hypothesis space are available for initial testing that results in the creation of updated hypothesis spaces (e.g., first and second hypothesis spaces H₁ and H₂). Limiting data processing module 304 to a set of setpoint attributes provides some inherent safety by ensuring that only desirable process conditions are available to the controllers 306 and multivariable plant 308. However, optimal and safe process parameters can be overlooked. In example embodiments, available process parameters are slowly varied to improve the variance of the hypothesis space H while mitigating risk. In the case of an IM machine, this can be done by perturbation of the original way-points by a small amount from real data to create new fictional points. In an example embodiment, a Bayesian classifier trained using an original hypothesis space H, and the trained classifier is used to classify the quality score of the perturbed hypothesis space. The successful instances are then added to the original hypothesis space H.

The systems and methods described herein can provide a platform to incorporate a number of important technologies into a single closed system with the purpose of improving an overall process. These tools touch a number of different important fields that can contribute and enhance the methodology. Some key areas are proposed with respect to each of the three main components of GIPO below.

Data Filters of Data Processing Module

When considering large amounts of data there are a number of filtering, data-mining and preprocessing techniques that can be used to prepare a data set that is appropriate and well formatted for the eventual machine learning processes to come. In practical applications many sensors are subjected to noise, adaptive filtering is one tactic to remove the noise that would be difficult to process for many AI algorithms. This is also true for missing data or false data, in these scenarios first principle models and predictors can be used to validate, repair or infer data on-line.

Process Control Module—Setpoint Selector

The optimization routine described above is based on a k nearest neighbors algorithm. There are a number of other possible optimization alternatives that are well developed. Examples include fuzzy networks and SPSA Genetic Algorithms, among others. Each of these algorithms have characteristics associated with them that would likely make them well suited for different applications.

Main Module Updater—Implementation

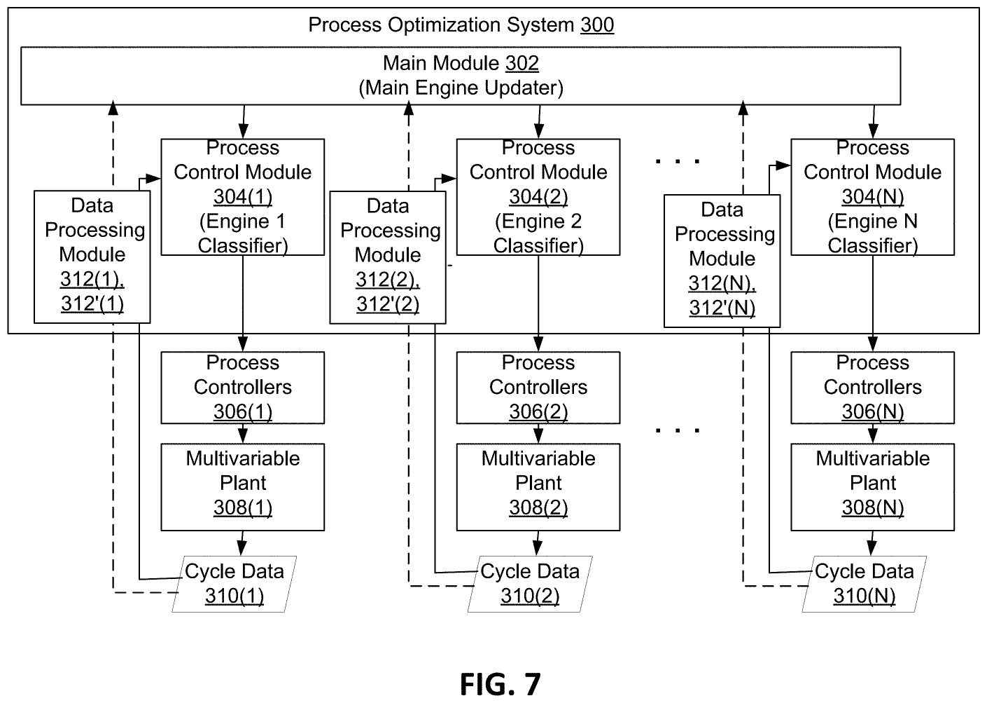

In the case where the number of process control modules 304 is 1 (e.g., as shown in FIG. 3), the main intelligent routine driving the evolution of the hypothesis space H is relatively simple. In the example presented in FIG. 3, GIPO system 300 is a distributed intelligence over two engines (main module 302 and process control module 304), where one engine (main module 302) populates the hypothesis space of an operating engine (process control module 304). This structure can be adapted so that the main engine (main module 302) controls a number of engine classifiers (process control modules 304(1) to 304(N) and processes controllers 306(1) to 305(N) of respective multivariable plants 308(1) to 308(N), as illustrated in FIG. 7.

Overview

In example embodiments, the engines (e.g., main module 302 and process control module 304) used in the GIPO system 300 may be implemented using machine learning to learn respective predictive functions. The main module 302 and process control module 304 may, in some applications, function to emulate an experienced operator's decision making process. In this regard, the smaller engine (process control module 304) is limited to a process dataset 303 (e.g., hypothesis space H) that is effectively equivalent to a set of experience scenarios provided by the main module 302. The artificial intelligence implemented by these two engines makes decisions to update the subject industrial process based on those positive experiences. The main module 302 is responsible for limiting the set of experiences that the smaller process control module 304 can then work with while the main module 302 considers more complex modelling, predicting and machine learning problems. The main module 302 is manipulating one or more process control modules 304 by providing them only with need-to-know information. In some applications, the process control modules 304 may manipulate process outcomes as an experienced human operator might but at a faster rate than a human being could. The use of two levels of engines may enable smaller (e.g., less computational and memory intensive) engines to be used for implementing the engine N classifiers 304.

Processing Unit

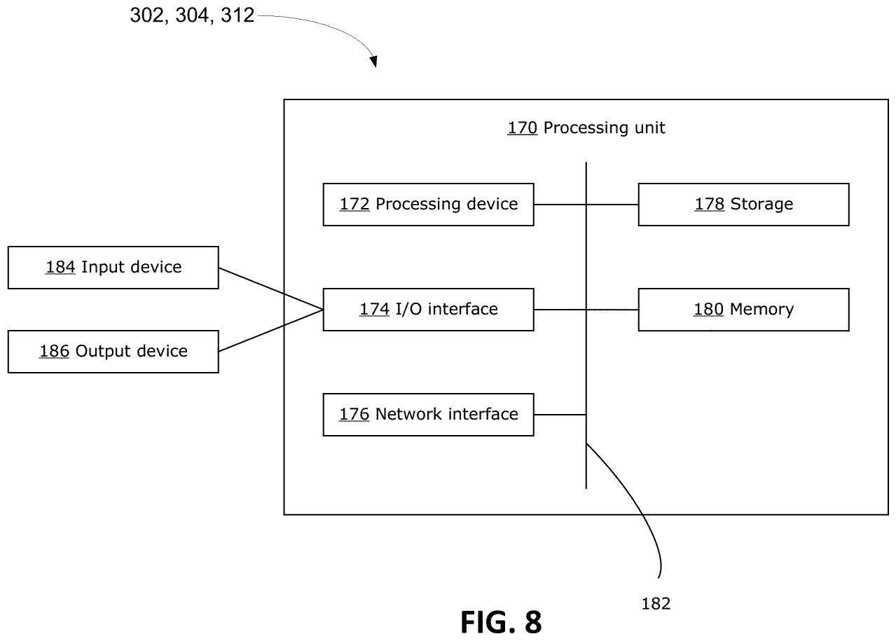

In example embodiments, system 300 is computer implemented using one or more computing devices. FIG. 8 is a block diagram of an example processing unit 170, which may be used in a computer device to execute machine executable instructions to implement one or more modules 302, 304, 312, 312′ of system 100. Other processing units suitable for implementing embodiments described in the present disclosure may be used, which may include components different from those discussed below. Although FIG. 8 shows a single instance of each component, there may be multiple instances of each component in the processing unit 170.

The processing unit 170 may include one or more processing devices 172, such as a processor, a general processing unit, (GPU), a microprocessor, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network.

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

1. A computer implemented method for controlling a cyclic industrial process, comprising:
receiving process attributes for a current sequence of process cycles;
comparing the process attributes for the current sequence of process cycles with process attributes for each of a plurality of historic instances, each historic instance including process attributes for a respective historic sequence of process cycles;
selecting an optimal set of one or more process setpoints based on the comparing; and
applying the optimal set of one or more process setpoints to a next process cycle in the current sequence of process cycles.

2. The method of claim 1 wherein the comparing comprises determining, for each of the plurality of historic instances, a respective likeness score for the historic instance relative to the current sequence of process cycles based on a computed difference of the process attributes for the historic instance to the process attributes for the current sequence of process cycles.

3. The method of claim 2 wherein each historic instance has an associated set of performance measurements, wherein selecting the optimal set of one or more process setpoints is based on: (i) selecting a historic instance having an optimal combination of likeness score and performance measurements as determined according to a defined optimization function; (ii) selecting the optimal set of one or more process setpoints from setpoints included in the process attributes for the selected historic instance.

4. The method of claim 3 wherein:
the process attributes for each historic instance include a respective attribute set for each of a defined number of process cycles including a final process cycle of the historic instance, the final process cycle being known as corresponding to a successful process cycle outcome;
the set of performance measurements associated with each historic instance are based on the respective attribute set for the final process cycle of the historic instance; and
the optimal set of one or more process setpoints are selected from setpoints included in the attribute set of the final process cycle of the selected historic instance.

5. The method of claim 3 wherein the cyclic industrial process is an injection molding process and each process cycle generates a respective injection molded part, wherein:
the process attributes for the current sequence of process cycles and for each of a plurality of historic instances include: (i) one or more measured attributes selected from a group including one or more of: coolant temperature, injection speed, screw position, hydraulic back pressure, barrel temperature, barrel pressure, energy consumption and part quality and (ii) one or more setpoint attributes selected from a group including one or more of: injection setpoint, packing setpoint, holding setpoint, plasticate setpoint, cool time setpoint, pack time setpoint, hold time setpoint and coolant flow rate setpoint; and
the performance measurements associated with each of the plurality of historic instances includes one more of: a quality index; an energy index and a cycle time.

6. The method of claim 1, comprising:
receiving process attributes for a plurality of process cycles performed by the industrial process over a period of time;
organizing the process attributes into multiple unique instances, each unique instance including the process attributes for a defined number of the process cycles, each of the unique instances having been identified according to predefined criteria as corresponding to a successful process outcome;
selecting at least some of the unique instances to use for the plurality of historic instances.

7. The method of claim 6 comprising updating the plurality of historic instances over time by adding new instances from the multiple unique instances to replace instances included in the plurality of historic instances.

8. The method of claim 6 comprising adding perturbances to a subset of the process attributes included in at least some of the multiple unique instances to introduce variations in future process cycles.

9. The method of claim 6 wherein organizing the process attributes into the multiple unique instances comprises:
organizing the process attributes into candidate instances, each candidate instance including the process attributes for the defined number of the process cycles;
computing one or more performance measurements for each of the candidate instances;
determining, based on the computed performance measurements, which of the candidate instances corresponds to a successful process outcome; and
selecting the candidate instances that have been determined to correspond to a successful process outcome for inclusion in the multiple unique instances.

10. The method of claim 9 wherein one or more performance measurements for each of the candidate instances includes a quality metric that is based on a quality of at least a final process cycle of the candidate instance.

11. A computer implemented method for controlling a cyclic industrial process, comprising:
assembling a main dataset that includes multiple historic instances for the industrial process, each of the historic instances including process attributes for a respective historic sequence of process cycles;
selecting, based on one or more intended process attributes for future process cycles, a process dataset that includes a subset of the historic instances;
selecting and applying an optimal set of one or more process setpoints for the industrial process during real-time operation of the industrial process based on a comparison of process attributes received in respect of process cycles completed during the real-time operation and the process attributes of the historic instances included in the process dataset.

12. A process control system for controlling a cyclic industrial process, comprising:
a first processing unit comprising one or more processing devices and one or more electronic storages that store non-transient software instructions that, when executed by the one or more processing devices, configure the first processing unit to:
receive process attributes for a current sequence of process cycles;
compare the process attributes for the current sequence of process cycles with process attributes for each of a plurality of historic instances, each historic instance including process attributes for a respective historic sequence of process cycles;
select an optimal set of one or more process setpoints based on the comparing; and
apply the optimal set of one or more process setpoints to a next process cycle in the current sequence of process cycles.

13. The system of claim 12 wherein the process attributes for the current sequence of process cycles are compared with the process attributes for each of the plurality of historic instances by: determining, for each of the plurality of historic instances, a respective likeness score for the historic instance relative to the current sequence of process cycles based on a computed difference of the process attributes for the historic instance to the process attributes for the current sequence of process cycles.

14. The system of claim 13 wherein each historic instance has an associated set of performance measurements, and the optimal set of one or more process setpoints is selected based on: (i) selecting a historic instance having an optimal combination of likeness score and performance measurements as determined according to a defined optimization function; (ii) selecting the optimal set of one or more process setpoints from setpoints included in the process attributes for the selected historic instance.

15. The system of claim 14 wherein:
the process attributes for each historic instance include a respective attribute set for each of a defined number of process cycles including a final process cycle of the historic instance, the final process cycle being known as corresponding to a successful process cycle outcome;
the set of performance measurements associated with each historic instance are based on the respective attribute set for the final process cycle of the historic instance; and
the optimal set of one or more process setpoints are selected from setpoints included in the attribute set of the final process cycle of the selected historic instance.

16. The system of claim 14 wherein the cyclic industrial process is an injection molding process and each process cycle generates a respective injection molded part, wherein:
the process attributes for the current sequence of process cycles and for each of a plurality of historic instances include: (i) one or more measured attributes selected from a group including one or more of: coolant temperature, injection speed, screw position, hydraulic back pressure, barrel temperature, barrel pressure, energy consumption and part quality and (ii) one or more setpoint attributes selected from a group including one or more of: injection setpoint, packing setpoint, holding setpoint, plasticate setpoint, cool time setpoint, pack time setpoint, hold time setpoint and coolant flow rate setpoint; and
the performance measurements associated with each of the plurality of historic instances includes one more of: a quality index; an energy index and a cycle time.

17. The system of claim 12 comprising a second processing unit comprising one or more further processing devices and one or more further electronic storages that store further non-transient software instructions that, when executed by the one or more further processing devices, configure the second processing unit to:
receive process attributes for a plurality of process cycles performed by the industrial process over a period of time;
organize the process attributes into multiple unique instances, each unique instance including the process attributes for a defined number of the process cycles, each of the unique instances having been identified according to predefined criteria as corresponding to a successful process outcome;
select at least some of the unique instances to use for the plurality of historic instances;
provide the plurality of historic instances to the first processing unit.

18. The system of claim 17 wherein the second processing unit is configured to update the plurality of historic instances over time by adding new instances from the multiple unique instances to replace instances included in the plurality of historic instances, and provide the updated plurality of historic instances to the first processing unit.

19. The system of claim 17 wherein the second processing unit is configured to add perturbances to a subset of the process attributes included in at least some of the multiple unique instances to introduce variations in future process cycles.

20. The system of claim 17 wherein the second processing unit is configured to organize the process attributes into the multiple unique instances by:
organizing the process attributes into candidate instances, each candidate instance including the process attributes for the defined number of the process cycles;
computing one or more performance measurements for each of the candidate instances;
determining, based on the computed performance measurements, which of the candidate instances corresponds to a successful process outcome; and
selecting the candidate instances that have been determined to correspond to a successful process outcome for inclusion in the multiple unique instances.
